(19) United States
(12) Patent Application Publication
(10) Pub. No.: US 2025/0226982 A1
(43) Pub. Date: Jul. 10, 2025

(54) Apparatuses, Systems, and Methods for Authentication of a Memory Module

(71) Applicant: Micron Technology, Inc., Boise, ID (US)

(72) Inventors: Matthew A. Prather, Boise, ID (US); Lance W. Dover, Boise, ID (US); Sujeet Ayyapureddi, Boise, ID (US)

(73) Assignee: Micron Technology, Inc., Boise, ID (US)

(21) Appl. No.: 18/970,539

(22) Filed: Dec. 5, 2024

Related U.S. Application Data
(60) Provisional application No. 63/619,195, filed on Jan. 9, 2024.
(60) Provisional application No. 63/661,392, filed on Jun. 18, 2024.

(51) Int. Cl. H04L 9/14

(52) U.S. Cl. CPC H04L 9/14

(57) ABSTRACT

A memory module includes one or more memory devices and a module logic chip. The module is coupled to a host which operates the memory devices. Certain features of the module may only be accessible once the module has authenticated with the host. For example, the module logic chip may perform asymmetric authentication with the host and the feature may be enabled only after successful authentication. In some embodiments, the module logic may additionally authenticate the memory devices. For example, the module logic chip may perform symmetric authentication on the memory devices after authentication with the host.

### CROSS-REFERENCE TO RELATED APPLICATIONS

This application claims the filing benefit of U.S. Provisional Application No. 63/619,195, filed Jan. 9, 2024 and U.S. Provisional Application No. 63/661,392, filed Jun. 18, 2024. These applications are incorporated by reference herein in their entirety and for all purposes.

### BACKGROUND OF THE INVENTION

Memory devices are used to store information. A host or controller may operate the memory device, for example by performing access operations such as a write operation to store information on the memory device or a read operation to retrieve information from the memory device. It may be desirable to protect certain features or operations of the memory device. There may be a need to ensure that the host is authorized to access these features before the memory device enables those features.

### BRIEF DESCRIPTION OF DRAWINGS

FIG. 1 is a block diagram of a memory system according to some embodiments of the present disclosure.

FIG. 2 is a block diagram of a semiconductor device according an embodiment of the disclosure.

FIG. 3 is a block diagram of authentication logic according to some embodiments of the present disclosure.

FIG. 4 is a flow chart of a method of authentication between the module and host according to some embodiments of the present disclosure.

FIG. 5 is a flow chart of a method of authentication between the module and the memory devices thereon according to some embodiments of the present disclosure.

FIG. 6 is a flow chart of authentication between the module and host and between the module and the memory devices of the module according to some embodiments of the present disclosure.

### DETAILED DESCRIPTION OF THE INVENTION

The following description of certain embodiments is merely exemplary in nature and is in no way intended to limit the scope of the disclosure or its applications or uses. In the following detailed description of embodiments of the present systems and methods, reference is made to the accompanying drawings which form a part hereof, and which are shown by way of illustration specific embodiments in which the described systems and methods may be practiced. These embodiments are described in sufficient detail to enable those skilled in the art to practice presently disclosed systems and methods, and it is to be understood that other embodiments may be utilized and that structural and logical changes may be made without departing from the spirit and scope of the disclosure. Moreover, for the purpose of clarity, detailed descriptions of certain features will not be discussed when they would be apparent to those with skill in the art so as not to obscure the description of embodiments of the disclosure. The following detailed description is therefore not to be taken in a limiting sense, and the scope of the disclosure is defined only by the appended claims.

Memory devices store information in a memory array. The array includes a number of memory cells, each of which may generally store a bit of information. The memory cells are organized at the intersection of word lines (rows) and bit lines (columns). The host may access specific memory cells (e.g., for read or write operations) by providing row and column addresses which specify one or more word lines and bit lines respectively. The memory devices may include various capabilities, some of which may be optional features which can be enabled/disabled/modified etc. based on various commands and settings.

Memory devices may be packaged together in various ways. A memory module may include a number of memory devices packaged together. The module may then be coupled to the host. Each memory devices may communicate information (e.g., data) back and forth along data terminals to the host. The host may provide other information, such as commands and addresses, to a hub chip or module logic chip packaged on the module, which may distribute the commands and addresses to the memory devices.

Certain features of the memory devices may be determined to be sensitive. For example, the memory devices may generally perform on-die error correction operations based on error correction information stored on the device along the device. During normal operations, the error correction information may remain entirely on the device. However, in certain modes the memory devices may instead provide the error correction information to the host. Since this may reveal details of the device's error correction operation and/or information about the error rate or other measured error characteristics, it may be desirable to ensure that only authorized hosts are able to receive this information. There may thus be a need for authentication between the host and module in order to determine if certain features can be enabled.

The present disclosure relates to apparatuses, systems, and methods for authentication of a memory module. A memory module includes a number of data devices (e.g., DRAMs) and a module logic chip. For example, the module logic chip may be a serial presence detect (SPD) chip or enhanced SPD (eSPD) chip. The module logic chip includes an authentication logic circuit which works with an authentication logic circuit of the host to perform authentication between the host and module logic chip. If the authentication is successful, the module logic chip may enable one or more features of the memory devices. If the host and module connection is not authenticated, then the feature may be disabled. In this manner features which are protected or otherwise sensitive may only be enabled when the module is coupled to an authorized host device.

In some embodiments, as well as authentication between the module logic and the host, further authentication may also be performed between the module logic circuit and the memory devices. For example, the memory devices may also include authentication logic circuits which authenticate with the authentication logic circuit of the module logic chip. This may add an extra layer of security, as it may help ensure that the memory devices are still coupled to an authorized module. In some embodiments, different authentication protocols may be used between the module logic chip and the host and between module logic chip and the memory devices. For example, asymmetric cryptography (e.g., public key encryption) may be used to authenticate between the module logic and the host, while a shared secret (e.g., symmetric cryptography, a password, a known or shared identifier, or combinations thereof) may be used to authenticate between the module logic chip and the memory devices.

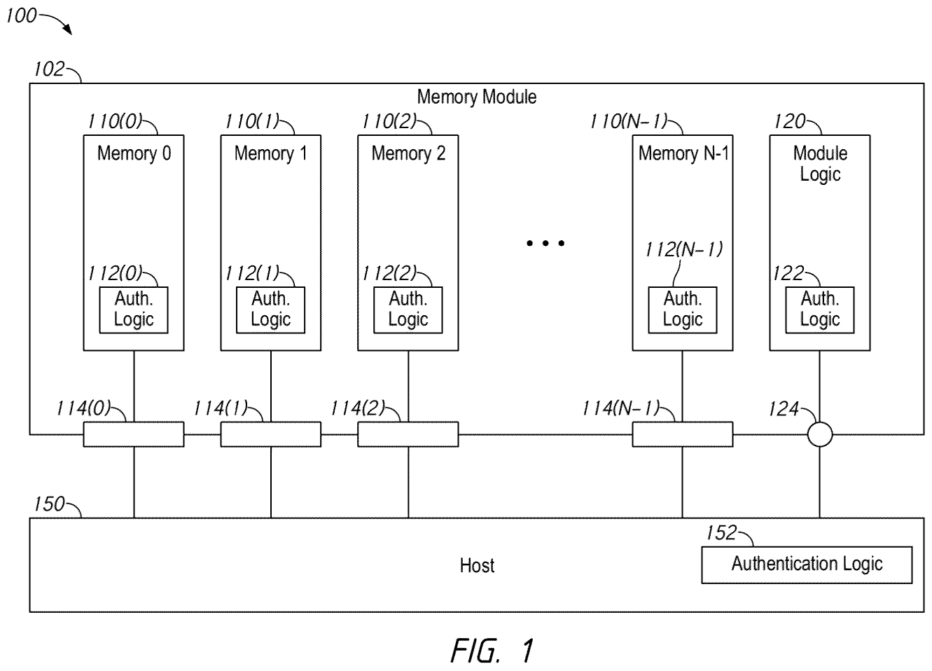

FIG. 1 is a block diagram of a memory system according to some embodiments of the present disclosure. The memory system 100 includes a memory module 102 and a host 150. The memory module 102 includes a number of memory devices 110 and a module logic chip 120. The module 102 may be a DIMM, CMM, or any other macro-functioning system of chips which includes memory devices. The host 150 may be a controller of the module 102, such as a processor (e.g., a CPU or GPU). The module logic chip 120 may be a SPD, power management integrated circuit (PMIC), a register, or a registered clock driver (RCD) or any other chip on the module 102. In some embodiments, multiple module logic chips may be used. For example, normal memory operations may be handled by a first memory chip while a separate chip handles authentication. The term module logic chip will be used to describe any combination of logic circuits and chips coupled to the memory module 102.

The memory devices 110 each include a memory array which stores information. The memory devices 110 are coupled to the host through respective channels 114. The channels include one or more data terminals which are used to communicate information back and forth between the host 150 and the memory devices 110, for example as part of access operations. The module 102 also is coupled to the host 150 along one or more additional connections, such as a command/address bus and command/address terminals 124, which may be used by the host 150 to operate the module 102. For example, the host 150 may provide an access command (e.g., a write or a read command) as well as row, column, and/or bank addresses along the command/address bus to the command/address terminals 124 as part of an access operation.

In an example access operation, the host 150 provides an access command (e.g., a read or write command) along with addresses along the C/A bus to the C/A terminals 124. The module logic chip 120 distributes the commands and addresses to the memory devices 110 along an internal C/A bus. In an example write operation, the module logic chip 120 receives and distributes a write command along with the addresses. The host 150 provides data along the channels 114 to the targeted memory devices 110. The memory devices write that data to the location(s) specified by the addresses. In some embodiments, the memory devices may generate error correction bits (e.g., parity bits) based on the written data, and write that to the array as well. In an example read operation, the module logic 120 receives a read command and addresses and distributes those to the memory devices 110. The memory devices retrieve the data stored in the memory array at the location(s) specified by the addresses and provide the data along the respective channels 114 to the host 150. In some embodiments, (and when ECC pass-through is disabled, as explained further herein) the devices may perform error correction on the read data based on the data and the error correction bits, and provide the corrected data along the channels 114.

The module 102 includes a module logic circuit 120 which includes an authentication logic circuit 122. The authentication logic circuit 122 communicates with an authentication logic circuit 152 of the module to authenticate the host 150. For example, the host authentication logic circuit 152 and the module authentication logic circuit 122 may perform authentication using asymmetric cryptography, such as public-key encryption, Rivest-Shamir-Adleman (RSA) encryption, elliptic curve, or combinations thereof. For example, the two authentication logic circuits 122 and 152 may each include a respective private key and a related public key. The public key may be information which can be retrieved (e.g., read) by an outside party. For example the host 150 may retrieve the module authentication logic circuit's 122 public key, and the module authentication logic circuit 122 may retrieve the host authentication logic circuit's 152 public key. The two private keys may remain protected in their respective devices. The two authentication logic circuits 122 and 152 may communicate a challenge back and forth in order to determine if the challenge message encrypted with the recipient's public key can be decrypted with the private key. By sending such messages back and forth, the two authentication logic circuits 122 and 152 may verify that both the host 150 and module 102 are in possession of private keys corresponding to (or mathematically linked to) their respective public keys.

In some embodiments, only authentication between the host 150 and module logic circuit 120 may be used. In some embodiments, after authentication between the host 150 and module logic circuit 120, the module logic circuit 120 may also authenticate itself with the memory devices 110. For example, responsive to authentication with the host authentication logic circuit 152, the module authentication logic circuit 122 may perform authentication with the authentication logic circuits 112 of the memory devices 110. In some embodiments, the protocol used for intra-module authentication may be different from the protocol used for inter-module authentication. For example, asymmetric authentication may be performed between the host and module while other forms of authentication, such as symmetric cryptography (e.g., secret key encryption), a password, a known/shared identifier, or combinations thereof, is performed between the module logic chip 120 and the memory devices 110.

In an example implementation, in symmetric authentication, the module authentication logic circuit 122 and each of the device authentication logic circuits 112 may include a secret key (which may be different than the private key used in the asymmetric authentication between the host and module). An authentication message, such as a message authentication code (MAC), may be encrypted based on the secret key and sent to the other device, which may authenticate it by determining if the message can be decrypted with the secret key stored on that device. For example, the module authentication logic circuit 122 may generate an encrypted message and provide it to one or more of the memory authentication logic circuits 112 or the memory authentication logic circuits 112 may generate an encrypted message and provide it to the module authentication logic circuit 122. In some embodiments, the module authentication logic circuit 122 and memory authentication logic circuits 112 may all share a same secret. In some embodiments, the memory authentication logic circuits 112 may each store different secrets, and the module authentication logic circuit 122 may store a number of different secrets, each of which matches with the secret of one memory device.

The use of different authentication protocols may be useful to take advantage of the different capabilities of the various chips. For example, the memory devices 110 may have more limited logic capabilities than the module logic circuit 120 and the host 150, which may make public key authentication, which is more logic intensive, difficult.

Responsive to authenticating the connection between the host 102 and the module 150, between the module logic 120 and memory devices 110, or both, the module 102 may enable, disable, or otherwise change the operation of one or more features of the memory module 102. In some embodiments, the feature may be a feature of the module logic circuit 120. In some embodiments, the feature may be a feature of the memory devices 110. In some embodiments, the feature may be enabled on selected ones of the memory devices 110. In some embodiments, the feature may be automatically enabled after authentication. In some embodiments, the host 150 may send a command to enable the feature after authentication.

In some embodiments, the authentication (between the host and module and/or between the module logic and the memory devices 110) may be performed when the host 150 and module 102 are first connected. In some embodiments, the authentication may be performed any time the module is powered on, reset, or otherwise re-initialized. In some embodiments, the authentication may be performed periodically. In some embodiments, the authentication may be performed on-demand, for example, the module 150 may issue a command to enable the feature, and responsive to that command the authentication may be performed. In some embodiments, any combination of the above authentication conditions may be used (e.g., when the device is powered on and also periodically thereafter).

In an example implementation, the feature may be an error correction pass-through feature. When the error correction pass-through is disabled, the memory devices 110 may perform error correction on the device, for example by generating error correction bits when data is written, and using those error correction bits to correct errors in the data when it is read and then provide the corrected data to the host 150. When the error correction pass-through is disabled, the error correction bits remain within the memory device. When error correction pass-through is enabled (e.g., after a successful authentication), the memory devices 110 still generate error correction information during write operations, but during read operations they provide the uncorrected data and the error correction information to the host 150. If the authentication is not successful, then the error correction pass-through mode cannot be enabled. Since extra bits are provided when the error correction pass-through is enabled compared to when it is disabled, the error correction bits may be provided by extending the burst length (e.g., number of serial bits) provided along the data terminals, or through other means such as by carving out one or more metadata bits with the error correction bits.

During an access operation, such as a read operation, data bits may be provided along one or more data terminals in parallel, and each terminal may be used to transmit a number of bits in series. The length of bits in the series may be referred to as the burst length. For example, in some modes, each channel may provide data along 2 data terminals with a burst length of 32, for a total of 64 bits. In some example embodiments, when the ECC pass through mode is disabled, then a first burst length may be used and when the ECC pass through mode is enabled (e.g., after authentication) then a second burst length may be used. For example, when the ECC pass through mode is disabled, then a burst length of 32 may be used, and when the ECC pass through mode is enabled, then a burst length of 36 may be used (e.g., for 64 bits of data and 8 bits of error correction). Other burst lengths and/or other numbers of data terminals may be used in other example embodiments.

In some embodiments, during an access operation such as a read operation metadata may be provided along with the data bits. The metadata may be information which is used to record information about the data. The metadata may be provided ‘in channel’ e.g., along the channel 114 or via a side band (e.g., through some other signal pathway such as the C/A bus). In some example embodiments, when the ECC pass through mode is disabled a first number of metadata bits may be provided along with the data. When the ECC pass through mode is enabled, some of those metadata bits may be carved out and replaced with error correction bits instead.

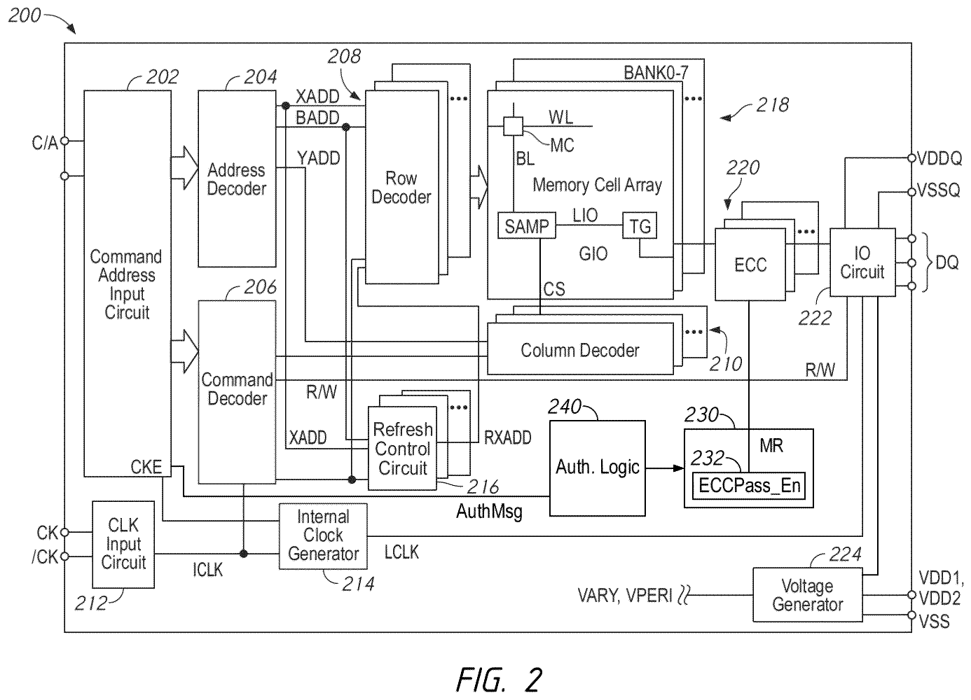

FIG. 2 is a block diagram of a semiconductor device according an embodiment of the disclosure. The semiconductor device 200 may be a semiconductor memory device, such as a DRAM device integrated on a single semiconductor chip. For example, the device 100 may implement one of the memory devices 110 of FIG. 1.

The semiconductor device 200 includes a memory array 218. The memory array 218 is shown as including a plurality of memory banks. In the embodiment of FIG. 2, the memory array 218 is shown as including eight memory banks BANK0-BANK7. More or fewer banks may be included in the memory array 218 of other embodiments.

Each memory bank includes a plurality of word lines WL, a plurality of bit lines BL, and a plurality of memory cells MC arranged at intersections of the plurality of word lines WL and the plurality of bit lines BL. The selection of the word line WL is performed by a row decoder 208 and the selection of the bit lines BL is performed by a column decoder 210. In the embodiment of FIG. 2, the row decoder 208 includes a respective row decoder for each memory bank and the column decoder 210 includes a respective column decoder for each memory bank.

The bit lines BL are coupled to a respective sense amplifier (SAMP). Read data from the bit line BL is amplified by the sense amplifier SAMP, and transferred to an ECC circuit 220 over local data lines (LIO), transfer gate (TG), and global data lines (GIO). Conversely, write data outputted from the ECC circuit 220 is transferred to the sense amplifier SAMP over the complementary main data lines GIO, the transfer gate TG, and the complementary local data lines LIO, and written in the memory cell MC coupled to the bit line BL.

The semiconductor device 200 may employ a plurality of external terminals, such as solder pads, that include command and address (C/A) terminals coupled to a command and address bus to receive commands and addresses, clock terminals to receive clocks CK and/CK, data terminals DQ coupled to a data bus to provide data, and power supply terminals to receive power supply potentials VDD, VSS, VDDQ, and VSSQ. The external terminals may couple directly to the controller (e.g., 150 of FIG. 1) and/or may couple to various buses/connectors of the module (e.g., 102 of FIG. 1).

The clock terminals are supplied with external clocks CK and/CK that are provided to an input circuit 212. The external clocks may be complementary. The input circuit 212 generates an internal clock ICLK based on the CK and/CK clocks. The ICLK clock is provided to the command decoder 206 and to an internal clock generator 214. The internal clock generator 214 provides various internal clocks LCLK based on the ICLK clock. The LCLK clocks may be used for timing operation of various internal circuits. The internal data clocks LCLK are provided to the input/output circuit 222 to time operation of circuits included in the input/output circuit 222, for example, to data receivers to time the receipt of write data. The input/output circuit 222 may include a number of interface connections, each of which may be couplable to one of the DQ pads (e.g., the solder pads which may act as external connections to the device 200).

The C/A terminals may be supplied with memory addresses. The memory addresses supplied to the C/A terminals are transferred, via a command/address input circuit 202, to an address decoder 204. The address decoder 204 receives the address and supplies a decoded row address XADD to the row decoder 208 and supplies a decoded column address YADD to the column decoder 210. The decoded row address XADD may be used to determine which row should be opened, which may cause the data along the bit lines to be read out along the bit lines. The column decoder 210 may provide a column select signal CS, which may be used to determine which sense amplifiers provide data to the LIO. The address decoder 204 may also supply a decoded bank address BADD, which may indicate the bank of the memory array 218 containing the decoded row address XADD and column address YADD.

The C/A terminals may be supplied with commands. Examples of commands include timing commands for controlling the timing of various operations, access commands for accessing the memory, such as read commands for performing read operations and write commands for performing write operations, refresh commands such as all-bank refresh and partial bank refresh, as well as other commands and operations. The access commands may be associated with one or more row address XADD, column address YADD, and bank address BADD to indicate the memory cell(s) to be accessed.

The commands may be provided as internal command signals to a command decoder 206 via the command/address input circuit 202. The command decoder 206 includes circuits to decode the internal command signals to generate various internal signals and commands for performing operations. For example, the command decoder 206 may provide signals which indicate if data is to be read, written, etc. The command decoder 206 may also provide one or more activations of a refresh signal REF responsive to a refresh command.

The device 200 may receive an access command which is a write command. When the write command is received, and a bank address, a row address and a column address are timely supplied with the write command, write data supplied to the data terminals DQ by the controller is provided along the data bus and written to memory cells in the memory array 218 corresponding to the row address and column address. The write command is received by the command decoder 206, which provides internal commands to perform the write operation. Write data is received by the IO circuit 222 and provided to optional ECC circuit 220, which generates error correction bits (e.g., parity bits) based on the write data. The row decoder 208 activates a word line based on the row address XADD, and the column decoder 210 couples bit lines selected by a column select signal CS (which is based on the column address YADD) to the LIO and GIO. The write data bits (and error correction bits) are written to the memory cells at the intersection of the active word line and the selected bit lines.

The device 200 may receive an access command which is a read command. When a read command is received, and a bank address, a row address and a column address are timely supplied with the read command, read data is read from memory cells in the memory array 218 corresponding to the row address and column address. The read command is received by the command decoder 206, which provides internal commands to activate the row indicated by the row address and couple the columns indicated by the column address through the LIO and GIO. The read data is provided through the IO circuit 222 to the DQ terminals and through those to the host device.

In some embodiments, the memory device may include error correction. When on-device error correction is used, the data and error correction bits are read from the array 218 to the ECC circuit 220 which detects and corrects errors in the data. For example, the ECC circuit 220 may use the error correction bits to locate and correct up to one bit of error in the read data. The corrected data may then be provided to the IO circuit 222. In some embodiments, the memory device 200 may include an ECC pass-through mode. When the ECC pass-through mode is enabled, the uncorrected data and error correction bits are provided to the IO circuit 222 and through that to the DQ terminals.

The device 200 includes a mode register 230. The mode register includes a number of storage elements, such as latch circuits, organized in registers. The registers store information such as settings of the memory. A controller (e.g., 150 of FIG. 1) may perform a mode register read operation to retrieve information from a specified register or a mode register write operation to write information to a specified register. Some registers may be read only to prevent the controller from modifying them. Some registers may be updated based on conditions or operations of the memory. For example a refresh rate multiplier may be set based on a measured temperature of the array 218. Some settings of the memory device may be protected, such that they can only be changed if the memory device 200 is in a properly authenticated connection with a module logic circuit and/or host device. For example, certain registers of the mode register 230 may be protected and may only be changed or updated from a default setting if the memory authentication logic circuit 240 indicates that the device 200 is in a properly authenticated configuration.

The memory device 200 includes a memory authentication logic circuit (e.g., 112 of FIG. 1). The memory authentication logic circuit 240 unlocks protected registers of the mode register 230 when the memory authentication logic circuit 240 determines that the device 200 is in an authenticated configuration (e.g., coupled to an authenticated module logic chip and/or coupled to an authenticated host). In some embodiments, only the connection between the module logic chip and host is authenticated, and the module logic chip may pass an authentication message to the memory authentication logic circuit 240 instructing it to unlock the protected registers. In some embodiments, the memory authentication logic circuit 240 may perform authentication with the module logic circuit (in addition to or instead of the authentication between the module logic circuit and the host). For example, the memory authentication logic circuit 240 may exchange authentication messages AuthMsg with the module logic circuit in order to authenticate the connection between the device 200 and the module logic chip.

In an example implementation, the authentication logic circuit 240 may include a secret, such as a secret key. The authentication messages AuthMsg may determine if the secret matches a secret stored on the module authentication logic. For example, the authentication message AuthMsg may be encrypted and decrypted based on the shared secret. If the authentication logic circuit 240 decrypts the authentication message AuthMsg it may indicate that the secret on the memory authentication logic 240 matches a secret on the module authentication logic circuit.

As an example of a protected feature, the mode register 230 may include an ECC pass through enable register 232 ECCPass_En. The ECC pass through enable register 232 may default to a disabled state which disables an ECC pass-through mode (e.g., causing the ECC circuit 220 to perform error correction on the device 200). When the memory authentication logic circuit 240 indicates that the device is in an authenticated configuration, the state of the ECC pass through enable register 232 may be changed (e.g., to enable an ECC pass through mode). In some embodiments, the state of the protected register, such as 232) may be automatically changed when the module authentication logic circuit 240 indicates an authenticated configuration. In some embodiments, the authentication may allow a mode register write operation to change a state of the protected register, such as 232.

In some embodiments, when the ECC pass through mode is enabled, the ECC circuit 220 may still generate the error correction bits during write operations. In some embodiments, when the ECC pass through mode is enabled, the ECC circuit 220 may be disabled, and the controller may generate the error correction bits and write them to the memory device 200. The data and error correction bits are written to the memory array 218. In a read operation, when the ECC pass-through mode is disabled, the ECC circuit 220 receives the data and error correction bits and uses the error correction bits to detect/correct errors in the data. For example, the ECC circuit may be able to locate and correct up to 1 bit of error (e.g., single error correction or SEC) in the data. The corrected data is provided to the IO circuit and through that to the host. In a read operation, when the ECC pass through mode is enabled, the ECC circuit 220 may be disabled, and the data and error correction bits may be provided to the IO circuit 222 and the IO circuit may provide both the uncorrected data and the error correction bits to the host. In some embodiments, the extra error correction bits may be provided via burst length extension, metadata carve out, or combinations thereof.

The device 200 includes refresh control circuits 216 each associated with a bank of the memory array 218. Each refresh control circuit 216 may determine when to perform a refresh operation on the associated bank. Responsive to the refresh command REF, the refresh control circuit 216 performs one or more refresh operations. As part of a refresh operation, the refresh control circuit 216 provides a refresh address RXADD (along with one or more refresh signals, not shown in FIG. 1). The row decoder 208 performs a refresh operation on one or more word lines associated with RXADD. The refresh control circuit 216 may perform multiple types of refresh operation, which may determine how the address RXADD is generated, as well as other details such as how many word lines are associated with the address RXADD.

The power supply terminals are supplied with power supply potentials VDD and VSS. The power supply potentials VDD and VSS are supplied to an internal voltage generator circuit 224. The internal voltage generator circuit 224 generates various internal potentials VARY, and the like based on the power supply potentials VDD and VSS supplied to the power supply terminals.

The power supply terminals are also supplied with power supply potentials VDDQ and VSSQ. The power supply potentials VDDQ and VSSQ are supplied to the input/output circuit 222. The power supply potentials VDDQ and VSSQ supplied to the power supply terminals may be the same potentials as the power supply potentials VDD and VSS supplied to the power supply terminals in an embodiment of the disclosure. The power supply potentials VDDQ and VSSQ supplied to the power supply terminals may be different potentials from the power supply potentials VDD and VSS supplied to the power supply terminals in another embodiment of the disclosure. The power supply potentials VDDQ and VSSQ supplied to the power supply terminals are used for the input/output circuit 122 so that power supply noise generated by the input/output circuit 122 does not propagate to the other circuit blocks.

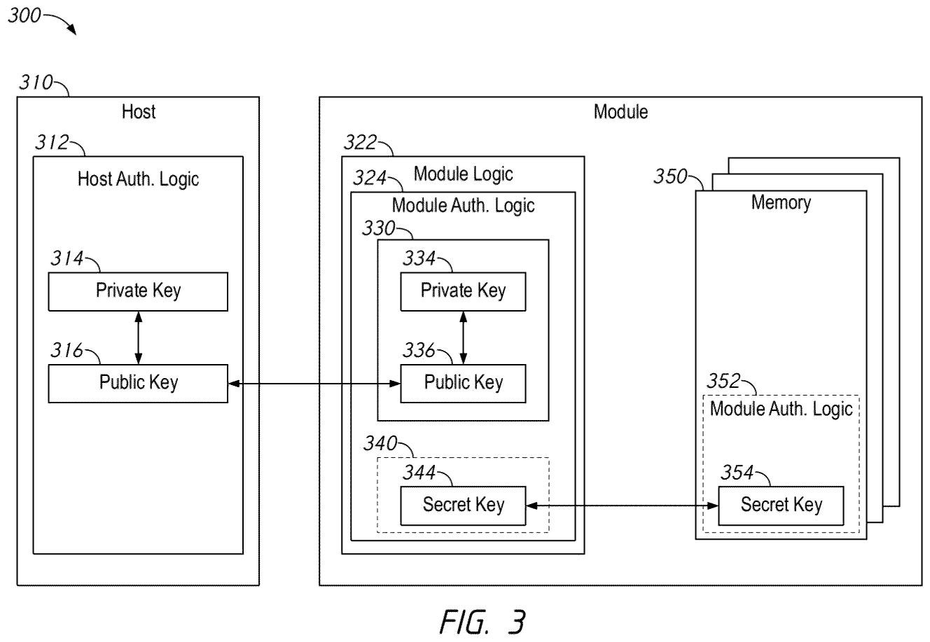

FIG. 3 is a block diagram of authentication logic according to some embodiments of the present disclosure. FIG. 3 shows a memory system 300, which may, in some embodiments, represent portions of the memory system 100 of FIG. 1. The memory system 300 includes a host 310 (e.g., 150 of FIG. 1) and a memory module 320 (e.g., 102 of FIG. 1). The memory module 320 includes a module logic chip 322 (e.g., 120 of FIG. 1 and/or 200 of FIG. 2) and one or more memory devices 350 (e.g., 110 of FIG. 1). For the sake of brevity only a single memory device 350 will be described in detail with respect to FIG. 3. The host 310 includes a host authentication logic circuit 312 (e.g., 152 of FIG. 1), the module logic chip 322 includes a module authentication logic circuit 324 (e.g., 122 of FIG. 1) and the memory 350 includes a memory authentication logic circuit 352 (e.g., 112 of FIG. 1 and/or 240 of FIG. 2). For the sake of clarity, only the authentication logic circuits 312, 324, and 352 are shown in FIG. 3 and other components, signal lines, etc., have been omitted.

An example authentication operation may be performed to authenticate the connection between the host 310 and module 320 and/or between the components of the module 320 in order to enable one or more features of the module 320. The authentication operation may include authentication between the host authentication logic circuit 312 and the module authentication logic circuit 324, authentication between the module authentication logic circuit 324 and the memory authentication logic circuits 352, or combinations thereof. In embodiments where both host/module and intra-module authentication are performed, the module authentication logic circuit 324 includes a host authentication portion 330 and a memory authentication portion 340. FIG. 3 shows an example implementation which may be used for the authentication protocols between the host and module and between the components of the module. Other authentication protocols may be used in other example embodiments.

The authentication between the host 310 and the module 320 (e.g., between the host authentication logic circuit 312 and the module authentication logic circuit 324) may be based on asymmetric cryptography. For example, the host authentication logic circuit 312 stores a host private key 314 and a host public key 316. The module authentication logic circuit 324 also stores a module private key 334 and a module public key 336. The host private key 314 and the module private key 334 will have non-matching values. The public keys 316 and 336 will also have different values from each other and from their respective private keys 314 and 334. However, the host public key 316 will be mathematically related to the host private key 314 and the module public key 336 will be mathematically related to the host private key 334, both using a suitable asymmetric key generation algorithms which uses techniques such as elliptic curve cryptography, RSA, or related.

During an example authentication between the host 310 and module 320 based on asymmetric cryptography, authentication messages or payloads may be sent back and forth between the host 310 and module 320 which are encrypted with the sender's private key, and can be decrypted with the sender's public key. For example, the host 310 may generate an encrypted message based on its private key 314 and provide the encrypted message to the module authentication logic circuit 330. The module authentication logic circuit 330 may read the host's public key 316 and use that to decrypt the message. If the decryption is successful, it may prove that the host is in possession of the private key which forms a valid key-pair with the public key 316 read by the module. The public key may be signed (e.g., by a trusted third party) to indicate that the key pair is a valid one and that the host should be trusted. For example, the public key may be certified with an x.509 certificate. Similarly, the module authentication logic circuit 324 may prepare an encrypted message based on its private key 334 and provide it to the host 310, which may read and use the public key 336 to decrypt the message. The module's public key 336 may also be signed. In this manner the two devices may confirm that the other device holds a valid key pair and thus authenticate each other.

The authentication between the devices of the module 320 (e.g., between the module authentication logic circuit 324 and the memory authentication logic circuit 352) may be based on a different protocol than the authentication between the host 310 and module 320. For example, the intra-module authentication between the module logic circuit 322 and memory device 350 may be based on symmetric cryptography, a password, a known/shared identifier, or combinations thereof. For example, the module authentication logic circuit 340 may store a secret such as a module secret key 344 and the memory authentication logic circuit 352 stores a matching secret such as a memory secret key 354. The two secret keys 344 and 354 must have matching values.

During an example authentication between the module logic 322 and memory 350, the module authentication logic circuit 324 and memory authentication logic circuit 352 may exchange authentication messages which demonstrate possession of their respective secret keys. For example, the module authentication logic circuit 340 may generate an authentication message encrypted with the module secret key 344. If the memory authentication logic circuit 354 can decrypt that message with the memory secret key 354, it may demonstrate that the module logic chip 322 and memory 350 share matching secret keys. Similarly, if the memory authentication logic circuit generates an authentication message encrypted with the memory secret key 354, then if the module authentication logic circuit 340 can decrypt that message based on the module secret key 344, it may demonstrate that the values of the keys match. In this way the connection may be authenticated.

In some embodiments, rather than directly use the secret keys 344 and 354 to encrypt and decrypt messages a shared session key, generated for use only during a specific authentication session may be used instead. In some embodiments, each of the memory devices 350 may store a secret key 354 with the same value. In some embodiments, each of the memory devices 350 may store secret keys with different values, and the module authentication logic circuit 324 may store a secret key for each memory device 350.

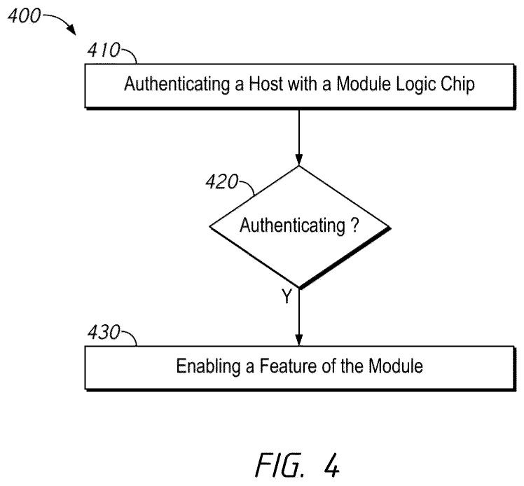

FIG. 4 is a flow chart of a method of authentication between the module and host according to some embodiments of the present disclosure. The method 400 may, in some embodiments, be implemented by one or more of the apparatuses or systems described herein. For example, the method 400 may be implemented by the memory system 100 of FIG. 1 and/or 300 of FIG. 3. For example the authentication may be performed between a module authentication logic circuit (e.g., 122 of FIG. 1 and/or 324 of FIG. 3) and a host authentication logic circuit (e.g., 152 of FIG. 1 and/or 312 of FIG. 3)

The method 400 includes box 410, which describes authenticating a host with a module logic chip. The authentication may include determining with the module authentication logic circuit if the host is an authorized host. The authenticating may be performed at connection, on power-up/reset, periodically, on-demand, or combinations thereof. The method 400 may include performing authentication based on asymmetric encryption, such as public key encryption. For example, the method 400 may include generating a public key and private key pair for the host device and generating a public key and private key pair for the module. The method 400 may include storing the respective key pairs in the host and module logic chip. The method 400 may include allowing access to the public key but not allowing access to the private.

In an example authentication operation between the host and the module, the method 400 may include encrypting a message with the sender's private key, providing the encrypted message to the recipient, and then the recipient decrypting the message with the sender's public key. The method 400 may also include determining if the sender's public key is signed by a trusted authority. In some embodiments, the method 400 may include sending a message from the host to the module and sending a message from the module to the host.

Box 410 is followed by box 420 which describes determining if the authentication was successful. For example, box 420 may include determining if the host and the module logic circuit have been loaded with matching private keys. If the host and module are successfully authenticated, box 420 is followed by box 430, which describes enabling a feature of the module. If the authentication is not successful, then the feature may remain disabled. In an example application, the feature may be an error correction pass-through mode.

The method 400 may include generating error correction bits (e.g., with ECC circuit 220 of FIG. 2) as part of a write operations. If the error correction pass-through mode is disabled, then the method 400 may include reading the data and associated error correction bits to the ECC circuit, correcting errors with the ECC circuit and providing the corrected data (but not the error correction bits) to the host. If the error correction pass-through mode is enabled, then the method 400 may include reading the data and associated error correction bits and then providing both the data (without correction) and the error correction bits to the host.

In some embodiments, the method 400 may include providing the error correction bits by extending a burst length along the data terminals when the feature is enabled. In some embodiments, the method 400 may include providing the error correction bits instead of metadata bits along with the data when the feature is enabled.

In some embodiments, the method 400 may include enabling the feature automatically after performing the authentication. For example, the method 400 may include enabling a feature enable register in the mode register (e.g., register 232 of mode register 230) with the module logic chip responsive to a successful authentication. In some embodiments, the method 400 may include enabling the feature responsive to a command (e.g., a mode register write command) from the host after successful authentication. For example, the method 400 may include preventing write operations to the feature enablement register until a successful authentication is performed.

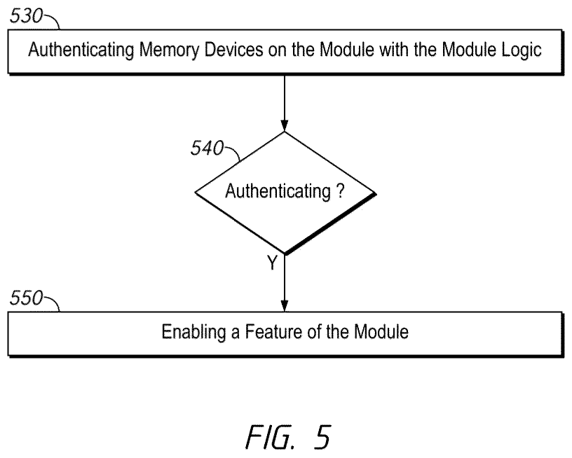

FIG. 5 is a flow chart of a method of authentication between the module and the memory devices thereon according to some embodiments of the present disclosure. The method 500 may, in some embodiments, be implemented by one or more of the apparatuses or systems described herein. For example, the method 500 may be implemented by a memory module 102 of FIG. 1 and/or 320 of FIG. 3. The authentication may be between a module logic chip (e.g., 120 of FIG. 1 and/or 322 of FIG. 3) and a memory device (e.g., 110 of FIG. 1, 200 of FIG. 2, and/or 350 of FIG. 3). For example the authentication may be performed between a host authentication logic circuit (e.g., 152 of FIG. 1 and/or 312 of FIG. 3) and a memory authentication logic circuit (e.g., 112 of FIG. 1, 240 of FIG. 2, and/or 352 of FIG. 3). Certain steps of the method 500 may be generally similar to the steps of the method 400 of FIG. 4. For the sake of brevity, certain operations already performed with respect to FIG. 4 will not be explained again with respect to FIG. 5. For example, the boxes 540 and 550 may be generally similar to the boxes 420 and 430 of FIG. 4.

The method 500 includes box 510, which describes authenticating memory devices on a module with a module logic circuit of the module. The authentication may include determining if the memory authentication logic circuit if the memory device is packaged on an authorized module. The authenticating may be performed at connection, on power-up/reset, periodically, on-demand, or combinations thereof. The method 500 may include performing authentication based on symmetric cryptography, a password, a known/shared identifier, or combinations thereof. For example, the method 500 may include loading the memory devices and the module logic chip with matching secret keys in a trusted environment, for example a factory. The method may include generating authentication messages based on the secret key stored on the source, providing it to a recipient and decrypting the message at the recipient based on the recipient's secret key to authenticate. For example, the method 500 may include generating an authentication message based on the secret key stored in the module authentication logic circuit, providing the encrypted message to the memory authentication logic circuit and decrypting the encrypted message with the secret key stored in the memory authentication logic circuit and vice versa (e.g., sending from the memory to the module). In some embodiments, the method 500 may include generating a session key for each authentication operation, where the session key is generated based on the stored secret keys and a random number generated in the module logic chip.

Box 510 is followed by box 520, which describes determining if the authentication was successful. For example, box 520 may include determining if the host and the memory device has matching secret keys (e.g., based on being able to decrypt messages authenticated based on each other's secret keys). If the module and the memory device are successfully authenticated, then box 520 is followed by box 530, which describes enabling a feature of the memory device. If the authentication is not successful, then the feature may remain disabled. In an example application, the feature may be an error correction pass-through mode. The error correction pass-through mode, as well as the enabling of the feature, may be generally similar to the examples described with respect to FIG. 4.

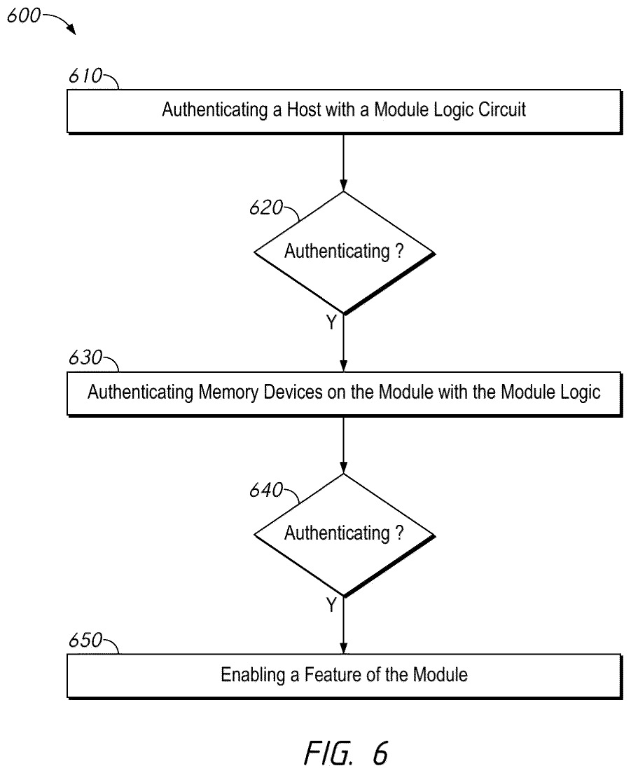

FIG. 6 is a flow chart of authentication between the module and host and between the module and the memory devices of the module according to some embodiments of the present disclosure. The method 500 may, in some embodiments, be implemented by one or more of the apparatuses or systems described herein. For example, the method 400 may be implemented by the memory system 100 of FIG. 1 and/or 300 of FIG. 3. For example the authentication may be performed between a module authentication logic circuit (e.g., 122 of FIG. 1 and/or 324 of FIG. 3) and a host authentication logic circuit (e.g., 152 of FIG. 1 and/or 312 of FIG. 3). The method 600 may generally be a combination of the methods 400 of FIG. 4 and 500 of FIG. 5. For example, the method 600 may include performing the steps of boxes 410 and 420 of FIG. 4 and then responsive to the successful authentication performing the steps 530-550 of FIG. 5. For the sake of brevity, the details of these two methods will not be repeated again with respect to FIG. 6.

The method 600 includes box 610, which describes authenticating a host with a module logic chip. The authentication may be asymmetric authentication such as public-key authentication. The authenticating may be performed between the authentication logic circuits of the host and a module logic chip (e.g., 152 and 122 of FIG. 1 respectively). The authenticating may be performed at connection, on power-up/reset, periodically, on-demand, or combinations thereof.

Box 610 is followed by box 620 which describes determining if the authentication was successful, and if so, box 620 is followed by box 630, which describes authenticating one or more memory devices (e.g., 110 of FIG. 1) on the module with the module logic chip (e.g., 120 of FIG. 1). The authentication may be symmetric authentication, a password, a known/shared identifier, or combinations thereof. The authentication of the memory devices may be performed responsive to the host and module successfully authenticating.

Box 630 is followed by box 640, which describes determining if the authentication between the module logic chip and the one or more memory devices was successful, and if so enabling a feature of the module. In this manner, if both authentication steps are not successful, then the feature may remain disabled. In an example application, the feature may be an error correction pass-through mode.

Of course, it is to be appreciated that any one of the examples, embodiments or processes described herein may be combined with one or more other examples, embodiments and/or processes or be separated and/or performed amongst separate devices or device portions in accordance with the present systems, devices and methods.

Finally, the above-discussion is intended to be merely illustrative of the present system and should not be construed as limiting the appended claims to any particular embodiment or group of embodiments. Thus, while the present system has been described in particular detail with reference to exemplary embodiments, it should also be appreciated that numerous modifications and alternative embodiments may be devised by those having ordinary skill in the art without departing from the broader and intended spirit and scope of the present system as set forth in the claims that follow. Accordingly, the specification and drawings are to be regarded in an illustrative manner and are not intended to limit the scope of the appended claims.

What is claimed is:

1. A system comprising:
a memory module comprising:
a plurality of memory devices; and
a module logic chip; and
a host coupled to the memory module,
wherein the module logic chip is configured to authenticate the host and enable a feature of the memory module responsive to the host being authenticated.

2. The system of claim 1, wherein the module logic chip includes a module authentication circuit configured to perform asymmetric cryptographic authentication between the module logic chip and the host.

3. The system of claim 2, wherein the module authentication circuit is further configured to perform authentication between the module logic chip and one or more of the plurality of memory devices, wherein the authentication includes symmetric cryptography, a password, a known/shared identifier, or combinations thereof, and
wherein the feature is enabled when both the authentication between the host and the module logic chip and between the module logic chip and the one or more of the plurality of memory devices is successful.

4. The system of claim 1, wherein the feature is an error correction pass-through mode.

5. The system of claim 4, wherein when the error correction pass-through mode is disabled the plurality of memory devices are configured to perform error correction and provide corrected data bits as part of a read operation and wherein when the error correction pass-through mode is enabled the plurality of memory devices are configured to provide uncorrected data bits and error correction bits as part of the read operation.

6. The system of claim 1, wherein the module logic chip is a serial presence detect (SPD) chip, an enhanced SPD (eSPD) chip, a power management integrated circuit (PMIC), a register, or a registered clock driver (RCD) of the memory module.

7. The system of claim 1, wherein the plurality of memory devices include a mode register configured to store an enablement setting of the feature, and wherein the enablement setting is set to an active state when the host is authenticated.

8. A method comprising:
authenticating a host of a memory module with a module logic chip of the memory module; and
enabling a feature of the memory module when the host is authenticated.

9. The method of claim 8, further comprising:
authenticating one or more of a plurality of memory devices on the memory module with the module logic chip; and
enabling the feature of the memory module when both the host is authenticated and the one or more of the plurality of memory devices are authenticated.

10. The method of claim 9, further comprising:
performing asymmetric cryptographic authentication between the host and the module logic chip; and
performing authentication between the module logic chip and the one or more memory devices which includes symmetric authentication, a password, a known/shared identifier, or combinations thereof.

11. The method of claim 8, further comprising enabling an error correction pass-through mode when the host is authenticated.

12. The method of claim 8, further comprising not enabling the feature if the host is not authenticated.

13. The method of claim 8, further comprising performing the authentication on connection of the host and the memory module, on power-up/reset, periodically, on demand, or combinations thereof.

14. The method of claim 8, further comprising:
receiving an authentication message from the host which was encrypted based on a public key;
decrypting the authentication message using a private key stored in the module logic chip; and
authenticating the host based, in part, on the successful decryption of the authentication message.

15. An apparatus comprising:
a plurality of memory devices;
a module logic chip comprising a module authentication logic circuit, wherein the module logic chip is configured to authenticate a connection with at least one of the plurality of memory devices and enable a feature of at least one of the plurality of memory devices only if the connection is authenticated.

16. The apparatus of claim 15, wherein the feature is an error correction pass through mode, and wherein when the feature is enabled, the at least one of the plurality of memory devices is configured to provide error correction information to the host device.

17. The apparatus of claim 15, wherein the plurality of memory devices each include a memory authentication logic circuit configured to authenticate the connection between the plurality of memory devices and the module logic chip.

18. The apparatus of claim 15, wherein the module authentication logic circuit is configured to authenticate a connection with a host device, and wherein the at least one of the plurality of memory devices enables the feature only if both the connection between the module logic chip and the host device and the connection between the at least one of the plurality of memory devices and the module logic chip are authenticated.

19. The apparatus of claim 18, wherein the module logic chip uses a different protocol to authenticate the connection with the host device than to authenticate the connection with the plurality of memory devices.

20. The apparatus of claim 19, wherein the module authentication logic circuit is configured to use asymmetric cryptographic authentication to authenticate the host device and use symmetric authentication, a password, a known/shared identifier, or combinations thereof to authenticate the at least one of the plurality of memory devices.
